(19) United States
(12) Patent Application Publication
(10) Pub. No.: US 2015/0009692 A1
(43) Pub. Date: Jan. 8, 2015

(54) LED LIGHTING DEVICE INCLUDING A DIFFUSER SYSTEM

(71) Applicant: AUTOMOTIVE LIGHTING REAR LAMPS FRANCE S.A.S, Saint-Julien-du-Sault (FR)

(72) Inventor: Alain Buisson, Trappes (FR)

(21) Appl. No.: 14/375,536

(22) PCT Filed: Jan. 30, 2013
(86) PCT No.: PCT/EP2013/051738

§ 371 Date: Jul. 30, 2014

(30) Foreign Application Priority Data
Jan. 31, 2012 (FR) 1200281

(51) Int. Cl. F21V 5/00; F21S 8/10

(52) U.S. Cl. CPC F21V 5/002; F21S 48/215
USPC 362/459

(57) ABSTRACT

The invention relates to a lighting device, in particular for a motor vehicle, comprising LEDs secured to a printed circuit board (PCB). The device is characterised in that a system is positioned substantially perpendicularly to the LEDs (5) in front of the illuminating face of the LED, said system comprising parallel opaque plates (1, 2), of which at least one of the faces is a light colour, preferably white. According to the invention, at least two of the aforementioned parallel plates rest on the PCB (4) and/or on the periphery thereof, on each side of at least one LED borne by said PCB, such as to define a channel having a base in which the LEDs are distributed; the wall-forming plates are deployed substantially perpendicularly to the mid-plane of the PCB such as to channel the light emitted by the LEDs, which leaves the device on the side of the plates opposite the above-mentioned side resting on or around the PCB; and the at least one light-coloured or white face of the plates faces into the channel.

The present invention relates to the field of lighting and signaling, in particular for motor vehicles. More particularly, it relates to a lighting device having several LEDs as light sources, in which the spatial diffusion of the emitted light is improved.

The regulations in force require, dependent on the vehicle type, different lighting or signal lamps. But aside from the volume of the lamp assembly, the performance and uniformity of illumination of individual lamps grouped in this way are major concerns.

Auxiliary transparent screens are already known from preceding art in which the light emitted by an auxiliary light source can propagate, these screens being intended to equip a lamp, in particular a rear lamp, of a motor vehicle. Local discontinuities provided in the material of the screen comprise focal spots for diffusion of the light outside these screens (see the published French patent No. 2 868 506).

The German patent application DE 101 01 795 describes flashing lamps, in particular for the front indicator lamps for motor vehicles, in which a source of auxiliary light for the position lamp illuminates an element positioned transversely in the space between the main lamp and the front lens, and obtains via this lens lighting in the same direction as that of the main lamp.

In French patent application 01 00048, published under number 2 819 040, there is a description of an optical or style component for lighting or signaling of motor vehicles. This component is of a transparent material, on the inside of which diffusive focal points for light are situated solely in predetermined locations to diffuse the light emitted by a source associated with the lighting or signaling device in question. This component may constitute the lens of a floodlight of a motor vehicle or an insert placed in such a floodlight.

German patent application DE 103 11 317 describes a vehicle lighting device comprising a light guide with diffusive structures essentially located at the focus of reflective surfaces which thus allow the diffusion of a homogeneous light.

The applicant has likewise designed, and described in the patent application FR 0905984, published under number 2953781, a new device for a motor vehicle lamp comprising a transparent optical material and at least one LED type light source arranged to emit light rays propagating within the thickness of said transparent optical material, which essentially comprises:
a plate of transparent optical material forming a curtain,
said plate comprising at least a bilateral elongated thickening with an essentially overall circular cross-section, having its mean longitudinal axis in the central plane of said plate and suitable for forming a light guide, and
at least one LED placed at at least one of the ends of said light guide, with its main axis orthogonal to longitudinal axis of said light guide.

In these miscellaneous applications and miscellaneous embodiments of luminous screens diffusing the light emitted by at least one LED, inhomogeneities can appear in the diffused light, particularly close to the guides with which the diffusive curtains or screens can be equipped.

As for the direct lighting by the LEDs of high or medium power, it is now recognized that it is dazzling and should not be generalized in this form.

It therefore appeared appropriate to attempt to homogenize the light output from the lighting devices and/or to mask any inhomogeneities that might occur therein.

The present invention aims to achieve a way of supplying lighting with a more uniform output and providing users with an output which is much less tiring or less dazzling than the LED lighting that is currently commercially available.

The new inventive lighting device, particularly intended for use, but without this imposing a limitation, in a signal lamp and/or exterior lighting or the interior ambient lighting of motor vehicles, comprises LEDs, advantageously fixed on PCBs (printed circuit boards), with a system comprising parallel plates placed substantially perpendicular to the LEDs, in front of the illuminating face of the LED, where at least one of the plate faces is a light color, preferably white, while said system advantageously comprises:
at least one LED, preferably multiple LEDs distributed along a line of any shape on a printed circuit board (PCB),
at least two parallel plates, which are composed of an opaque material and form a wall, resting on said PCB and/or on the periphery thereof, on each side of at least one LED borne by said PCB, such as to define a channel having a base in which said LEDs are distributed, the plates being deployed substantially perpendicular to the central plane of said PCB such as to channel the light emitted by said LEDs which leaves said device on the side of said plates opposite the aforementioned side resting on or around the PCB, while the device is orientated such that the LEDs emit the light into said channel, and while the device comprises, optionally, a wider zone or a flared zone at its free end, through which the light emitted by the LEDs exits the device when the latter are illuminated by a power supply and appropriate circuit elements, which functionally supplement the inventive device.

Although the inventive device can be of any shape or size, it shall be described below with reference to a device forming a lighting, marking and/or signal lamp for motor vehicles, and with reference to an embodiment in which the aforementioned opaque walls form the outsides of two hollow cylinders, of respective radii R and r, arranged in parallel with each other, in a concentric manner, resting on a PCB on which are placed n LEDs, regularly or irregularly spaced relative to each other, while said LEDs are arranged so that they emit a light beam directed substantially diametrically in the passage of width R-r as defined by the aforementioned opaque plates.

In practice, the opaque walls can define an annular channel or passage, the shape of which need not necessarily be circular, but can also be quadrangular, polygonal, or others, regular or irregular, or likewise a straight or sinous channel. In the latter case, the walls possess identical or homothetic curves, of alternating curvature directions and with sandwiched plane parts.

In a preferred embodiment, the LEDs are arranged in a substantially regular manner to match a geometric shape such as, for example, a circle on a PCB type substrate.

The invention will be better understood and its other objectives, advantages and characteristics will become more apparent in the light of the following detailed description of one typical illustrative embodiment and alternative or optional inventive embodiments.

The inventive device obtains its best results in terms of the diffusion and scattering of the light of the LEDs when the LEDs or the PCB bearing the LEDs are placed at an angle up to approximately 20°, and preferably of about 15°, with respect to the plane of the cross-section of said plates forming the channel for the light from the LEDs.

There is evidence that in this way the light emitted by the LEDs reflects off the internal walls of the channel defined between two opaque plates and diffuses/scatters before traveling towards the channel outlet from where it is visible to an observer suitably positioned in an appropriate field of vision.

The embodiments described below are purely illustrative and non-limiting, in particular with reference to the attached drawing plates in which:

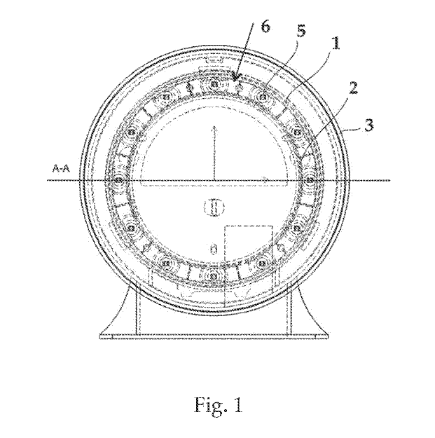

FIG. 1 represents a front schematic elevation view of an inventive lighting device on a base; and

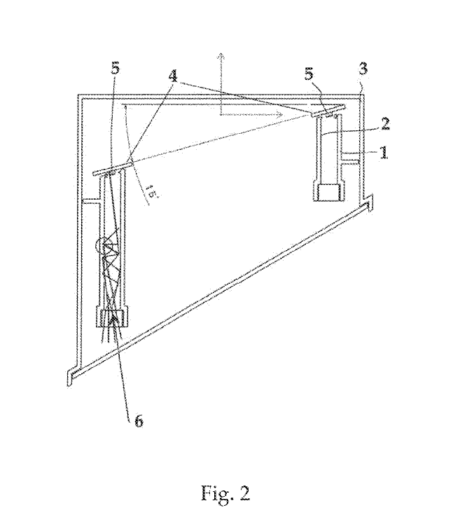

FIG. 2 represents a schematic cross-sectional view along A-A of the lighting device according to FIG. 1.

As shown by FIGS. 1 and 2 in the presented embodiment, the inventive lighting device can comprise a system of concentric tubes 1, 2 fixed in an appropriate manner on the inside of a housing 3 and secured on a base in the represented illustrative example. In practice, the base can be an element of the bodywork or motor vehicle structure, for example.

A printed circuit board (PCB) 4 comprising LEDs 5 is placed in the bottom of said housing.

To be operational, such a device is configured so that it can be connected to an appropriate source of electrical power.

As can be seen in FIG. 2, the LEDs are advantageously arranged at an angle, for example approximately 15°, relative to the transverse plane of the walls forming the channel. Their light beam is thus reflected a maximum number of times against the walls of said crown.

The inventive device can comprise separately, or in combination, optional or alternative characteristics, amongst which are in particular:
the PCB of the LED has a circular geometry with n LEDs (where n is an integer between 4 and 20, preferably equal to 12) arranged on its perimeter, preferably at essentially identical distances between two consecutive LEDs;
the LEDs are fixed on a PCB, on the front face of which the aforementioned tube is located in front of said LED PCB, advantageously in such a way that its longitudinal axis is perpendicular to the plane of said PCB;
at least the inner surface of the opaque plates is made of a white-colored material or similar and/or is lined with a white-colored coating or similar;
said inner surface of the opaque plates, that is the surface facing the inside of the channel which they define for the LEDs concerned, is preferably provided with rough spots. Such a rough wall scatters the light from the LEDs more effectively;
to compensate for the fact that a small proportion of the light beam of the LEDs can be attenuated or lost due to unwanted reflections or do not succeed in reaching the channel exit, it is recommended that LEDs are used having a maximum flux higher than the LEDs currently used in devices not provided with this light channeling, for example by replacing 20 lumen LEDs with 40 lumen LEDs;
the length to diameter ratio of said tube (excluding the thickened end part) is advantageously in the range 3 to 10 and preferably in the range 4 to 7 and most preferably about 5;
the width of the channel between two parallel opaque plates is preferably approximately 10 to 15 mm;
the light emission axis is advantageously parallel to the axis conventionally referred to as the X axis of the vehicle;
the fixing of said channel system in the axis of the main beam originating from said LEDs is performed using an appropriate fastening on the wall of a supporting circular module supporting the aforementioned n LEDs;
said LED supporting module may have a front face of which the main plane is angled relative to the longitudinal axis of said tubular system;
the electrical power supply to the LED PCBs is implemented using conventional means known to a person skilled in the art.

Another subject of the invention comprises a motor vehicle equipped with at least one device as described here.

In such a device, the LEDs emit rays which are essentially reflected by the inner wall of said tubes; after successive reflections of one and the same ray of light, it has acquired a beam width and uniformity which make it appear, to the human eye located so that it can see the exit of said tubes, as a light ray that remains powerful, but is significantly more uniform and less dazzling than the ray emitted at the start by a same LED assembly not equipped with an inventive device.

A flaring 6 at the ends of said tubes is optional; it makes it possible to increase the width and luminous flux of the beam exiting said tube and thus to give said beam of light rays exiting said tube a doubled width and exceptional uniformity, unusual in the current state of knowledge of a person skilled in the art and the implementations that they could create based on this knowledge.

The diameter of the aforementioned module can be, for example, between approximately 10 and 15 centimeters for a main lighting device, such as for example a rear light of a motor vehicle.

For automotive applications, a person skilled in the art will understand that the inventive device is placed in practice in the normal locations of the motor vehicle body. In a more general way, said device can likewise be used, with appropriately sized and configured adaptations, on the inside of the motor vehicle passenger compartment, and even more generally for all domestic and commercial usages, in any location where it is desired to have lighting improved in this way by use of an inventive device.

1. A lighting device, in particular for a motor vehicle, comprising LEDs, advantageously fixed on a printed circuit board or PCB, characterized in that there is placed, substantially perpendicularly to the LEDs (5) and in front of the illuminating face of the LED, a system comprising parallel opaque plates (1, 2), of which at least one of the faces is a light color, preferably white,
at least two of said parallel plates resting on the PCB (4) and/or on the periphery thereof, on each side of at least one LED borne by said PCB, such as to define a channel having a base in which said LEDs are distributed, and
the wall-forming plates being deployed substantially perpendicularly to the central plane of said PCB such as to channel the light emitted by said LEDs, which leaves said device on the side of said plates opposite the aforementioned side resting on or around the PCB, and
the at least one light-colored or white face of said plates facing into the channel.

2. The device as claimed in claim 1, characterized in that it moreover comprises a wider zone or a flared zone at its free end, through which the light emitted by the LEDs (5) exits the device when the latter are illuminated.

3. The device as claimed in either of claims 1 and 2, characterized in that the opaque walls (1, 2) form the outsides of two hollow cylinders, of respective radii R and r, arranged in parallel with each other, in a concentric manner, resting on a PCB (4) on which are placed n LEDs (5), regularly or irregularly spaced relative to each other, while said LEDs are arranged so that they emit a light beam directed substantially diametrically in the passage of width R-r as defined by the aforementioned opaque plates.

4. The device as claimed in any one of claims 1 to 3, characterized in that said opaque walls define an annular channel or passage with a circular, quadrangular, regular or irregular polygonal shape or likewise a straight or sinous channel.

5. The device as claimed in any one of claims 1 to 4, characterized in that it comprises plates (1, 2) forming a concentric tube assembly, while the LEDs (5) or the PCB (4) bearing the LEDs (5) are placed at an angle up to approximately 20°, and preferably of about 15°, with respect to the plane of the cross-section of said plates forming the channel for the light from said LEDs.

6. The device as claimed in claim 5, characterized in that said concentric tubes are fixed to the inside of a housing (3).

7. The device as claimed in claim 5, characterized in that the LEDs (5) are fixed on a PCB (4), on the front face of which said tube is located in front of said LED PCB, advantageously in such a way that said PCB is substantially inclined by about 15° relative to the longitudinal axis of said tube.

8. The device as claimed in any one of claims 1 to 7, characterized in that the PCB (4) of LEDs (5) has a circular geometry, while the n LEDs, where n is an integer between 4 and 2, preferably equal to 12, are arranged on its perimeter, preferably at essentially identical distances between two consecutive LEDs (5).

9. The device as claimed in any one of claims 1 to 8, characterized in that the surface of the opaque plates (1, 2) facing the inside of said channel is provided with rough spots.

10. The device as claimed in any one of claims 6 to 9, characterized in that it moreover comprises an end flaring (6) of said tubes, such that the width and luminous flux of the bundle of light rays exiting the same are increased.

11. A motor vehicle equipped with at least one device as claimed in any one of claims 1 to 10.
